(19) United States
(12) Patent Application Publication
(10) Pub. No.: US 2025/0106741 A1
(43) Pub. Date: Mar. 27, 2025

(54) COMMUNICATION METHOD AND COMMUNICATION APPARATUS FOR WIRELESS LOCAL AREA NETWORK SENSING MEASUREMENT

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/729,228

(22) PCT Filed: Jan. 18, 2022
(86) PCT No.: PCT/CN2022/072591

§ 371 Date: Jul. 16, 2024

(51) Int. Cl. H04W 48/16; H04W 84/12

(52) U.S. Cl. CPC H04W 48/16; H04W 84/12

(57) ABSTRACT

A communication method for wireless local area network (WLAN) sensing measurement includes determining, by a first device, a first message frame, and sending, by the first device, the first message frame; where the first message frame includes identification used to identify first information related to the first device, and the first information includes first identification information used to identify the first device as at least one of a receiver or a transmitter of a WLAN sensing frame.

### CROSS-REFERENCE TO RELATED APPLICATIONS

The present application is a U.S. National Stage of International Application No. PCT/CN2022/072591, filed on Jan. 18, 2022, the entire content of which is incorporated herein by reference for all purposes.

### BACKGROUND

The wireless local area network (WLAN) has the characteristics of flexibility, mobility and low cost, etc. With the development of communication technologies and the growth of user requirements, researches on the application of the WLAN are being gradually deepened. For example, WLAN sensing is currently researched, and the main application scenarios of the WLAN sensing are location discovery in dense environments (home and enterprise environments), proximity detection and presence detection, etc.

### SUMMARY

The present disclosure relates to the field of wireless communication and, more specifically, to a communication method and communication apparatus for wireless local area network sensing measurement. Various embodiments of the present disclosure provide technical solutions as follows.

According to an embodiment of the present disclosure, there is provided a communication method for WLAN sensing measurement. The communication method includes: determining, by a first device, a first message frame, and sending, by the first device, the first message frame; where the first message frame includes first information for identifying and related to the first device, and the first information includes first identification information for identifying that the first device is a receiver and/or a transmitter of a WLAN sensing frame.

According to an embodiment of the present disclosure, there is provided a communication method for WLAN sensing measurement. The communication method includes: receiving, by a second device, a first message frame from a first device, where the first message frame includes first information for identifying and related to the first device, and the first information includes first identification information for identifying that the first device is a receiver and/or a transmitter of a WLAN sensing frame; and obtaining, by the second device, the first information from the first message frame.

According to an embodiment of the present disclosure, there is provided a communication device. The communication device includes a memory, a processor and a computer program stored in the memory and runnable on the processor. The processor, when executing the computer program, implements the method described above.

According to an embodiment of the present disclosure, there is provided a computer-readable storage medium. The computer-readable storage medium stores a computer program. The computer program, when executed by a processor, implements the method described above.

### BRIEF DESCRIPTION OF THE DRAWINGS

The above and other features of the embodiments of the present disclosure will become more apparent by describing in detail exemplary embodiments of the present disclosure with reference to the accompanying drawings, in the drawings:

FIG. 1 illustrates exemplary manners of WLAN sensing;

FIG. 2 illustrates an exemplary WLAN sensing measurement process;

FIG. 3 illustrates exemplary manners of WLAN sensing measurement methods:

FIG. 4 is a flowchart illustrating a communication method according to an embodiment:

FIG. 5 is a flowchart illustrating a communication method according to an embodiment:

FIG. 6 illustrates an information interaction process between a transmitter and a receiver and a sensing measurement process;

FIG. 7 is a flowchart illustrating another communication method according to an embodiment:

FIG. 8 is a flowchart illustrating another communication method according to an embodiment:

FIG. 9 is a block diagram illustrating a communication apparatus according to an embodiment.

### DETAILED DESCRIPTION

The following description with reference to the accompanying drawings is provided to assist in fully understanding of various embodiments of the present disclosure as defined by the appended claims and their equivalents. The various embodiments of the present disclosure include various specific details, but these specific details are considered exemplary only. In addition, descriptions of well-known techniques, functions and constructions may be omitted for the sake of clarity and brevity.

Terms and phrases used in the present disclosure are not limited to their written meanings, but are used only by the inventor to enable a clear and consistent understanding of the present disclosure. Accordingly, for those skilled in the art, the description of various embodiments of the present disclosure is provided for illustrative purposes only and is not intended to be limiting.

It should be understood that the singular forms “one”, “a”, “the”, and “this” used herein may also include the plural form, unless the context clearly indicates otherwise. It should be further understood that the term “include” as used in the present disclosure refers to the presence of the described features, integers, steps, operations, elements, and/or components, but does not preclude the presence or addition of one or more other features, integers, steps, operations, elements, components, and/or groups thereof.

It will be understood that while the terms “first”, “second”, etc. may be used herein to describe various elements, these elements should not be limited by these terms. These terms are only used to distinguish one element from another. Thus, without departing from the teaching of the exemplary embodiments, the first element discussed below may be referred to as the second element.

It should be understood that when an element is referred to as “connected” or “coupled” to another element, it may be directly connected or coupled to the another element, or there may be an intermediate element. In addition. “connect” or “couple” as used herein may include wireless connecting or wireless coupling. The term “and/or” or the expression “at least one/at least one of . . . ” as used herein includes any of and all of combinations of one or more of the relevant listed items.

Unless otherwise defined, all terms used herein, including technical and scientific terms, have the same meaning as generally understood by those ordinary skilled in the art to which the present disclosure belongs.

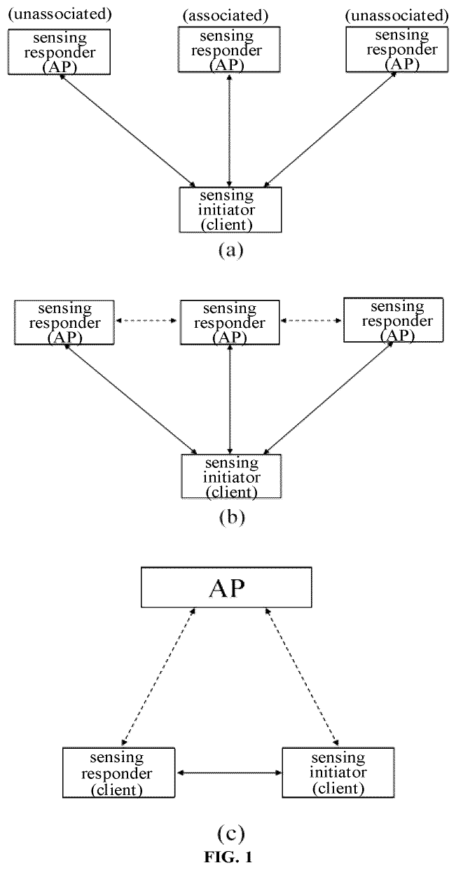

FIG. 1 illustrates exemplary manners of WLAN sensing.

The process of WLAN sensing may be that an initiator initiates the WLAN sensing (e.g., initiates a WLAN sensing session), there may be a plurality of responders responding thereto, and specific possible manners may be as illustrated in (a), (b) and (c) in FIG. 1.

Referring to (a) in FIG. 1, when the WLAN sensing initiator (e.g., a client) initiates the WLAN sensing, a plurality of associated or unassociated WLAN sensing responders (e.g., three access points (APs)) may respond thereto. Here. “associated” may mean that an associated connection for communication is established between the initiator and the responder, and “unassociated” may mean that the associated connection for communication is not established between the initiator and the responder.

As an example, the client may include, but is not limited to, a cellular phone, a smart phone, a wearable device, a computer, a personal digital assistant (PDA), a personal communication system (PCS) device, a personal information manager (PIM), a personal navigation device (PND), a global positioning system, a multimedia device, or an Internet of Things (IoT) device, etc.

The AP may be a wireless switch for a wireless network, or may be an access device of the wireless network. The AP may include a software application and/or a circuit, thereby enabling other types of nodes in the wireless network to communicate via the AP with the outside and inside of the wireless network. As an example, the AP may be a terminal device or a network device equipped with a wireless fidelity (Wi-Fi) chip.

(b) in FIG. 1 is similar to (a) in FIG. 1, but in (b) of FIG. 1, communication may be performed between responders (APs).

Referring to (c) in FIG. 1, both the WLAN sensing initiator and the WLAN sensing responder may be clients, and the initiator and the responder may communicate through connecting to the same AP.

Although it is illustrated in (a), (b) and (c) in FIG. 1 that the client serves as the initiator and the AP serves as the responder, the present disclosure is not limited thereto, e.g., the AP may serve as the initiator, and the client may serve as the responder. In an embodiment of the present disclosure, the AP may also be referred to as an AP site (AP STA), and the client may be referred to as a non-AP site (Non-AP STA), or may be referred to simply as “STA”. Furthermore, the number of the initiator and the number of the responder are not limited to those shown in (a), (b) and (c) of FIG. 1.

As an illustrative embodiment, the process of the WLAN sensing may include the WLAN sensing session establishment, the WLAN sensing measurement establishment, the WLAN sensing measurement, and the feedback of the WLAN sensing measurement. In the WLAN sensing session establishment, operational parameters associated with the sensing session may be determined and exchanged between devices. In addition, one WLAN sensing session establishment may include a plurality of WLAN sensing measurement establishments. In a WLAN sensing measurement establishment, working parameters in the sensing measurement may be defined, and one or more sensing measurement exchanges may be included. In the WLAN sensing measurement, a WLAN sensing measurement result may be obtained by performing one or more WLAN sensing measurement exchanges.

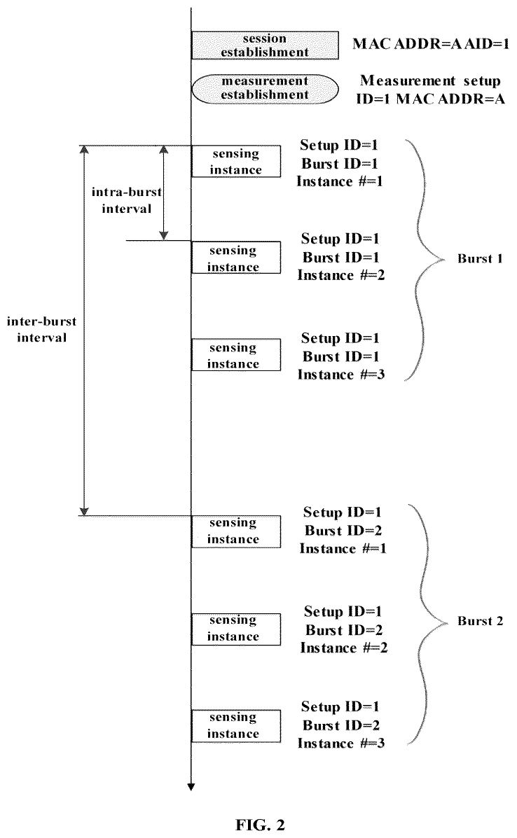

The WLAN sensing may be applied at a 60 GHz spectrum, and the process may be as shown in FIG. 2.

FIG. 2 illustrates a WLAN sensing session establishment and a WLAN sensing measurement establishment under that WLAN sensing session establishment. However, the present disclosure is not limited to this. The process of the WLAN sensing may include a greater number of WLAN sensing session establishments, and each WLAN sensing session establishment may include a greater number of WLAN sensing measurement establishments. In the WLAN sensing session establishment, a media access control (MAC) address (ADDR) of the initiator and an identifier AID of the responder may be identified. In the WLAN sensing measurement establishment, a measurement establishment identifier (Measurement setup ID) and the MAC ADDR of the initiator may be identified.

Each WLAN sensing measurement establishment may include one or more bursts, and each burst may include one or more WLAN sensing measurement exchanges (shown as a “sensing instance” in FIG. 2). A burst represents a specific time interval, and one or more WLAN sensing measurement exchanges may be performed within a burst. Although two bursts (Burst 1 and Burst 2) are illustrated in FIG. 2, and each burst includes three WLAN sensing measurement exchanges (sensing instances), this is only exemplary, and the present disclosure is not limited to this. The number of bursts in each WLAN sensing measurement establishment and the number of sensing instances in each burst may be varied.

With continued reference to FIG. 2, each WLAN sensing measurement exchange may be provided with a corresponding identifier (Instance #), and may correspond to a corresponding measurement establishment identifier (Setup ID) and a burst identifier (Burst ID). The time interval between adjacent WLAN sensing measurement exchanges within a burst may be referred to as an intra-burst interval, and the time interval between adjacent bursts may be referred to as an inter-burst interval.

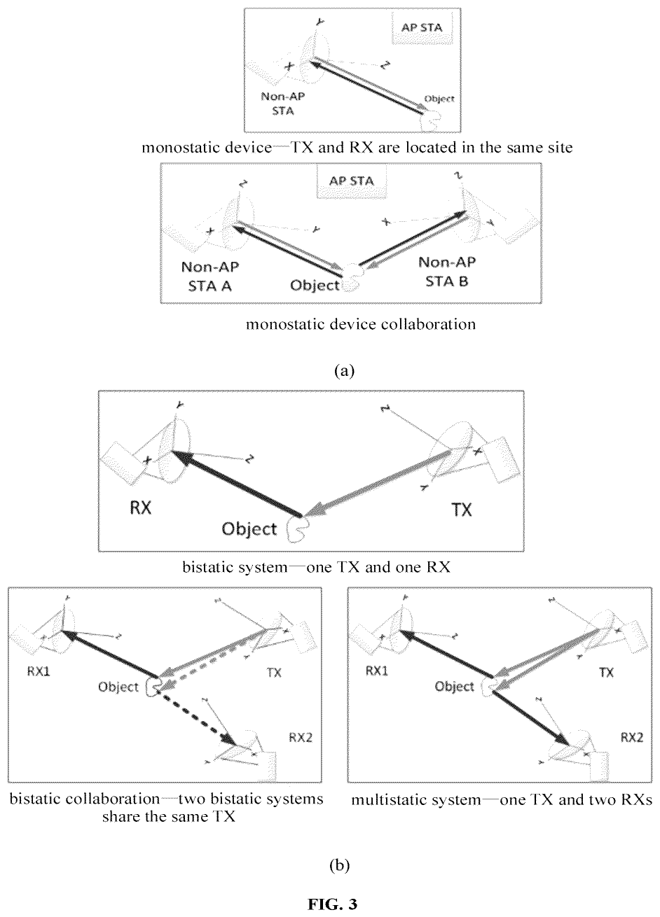

In millimeter wave applications, a plurality of measurement methods may exist. That is, various measurement methods may be used in performing each WLAN sensing measurement exchange (sensing instance). As shown in FIG. 3, exemplary manners of different measurement methods are illustrated.

A monostatic device and its collaborative measurement manner are illustrated in (a) of FIG. 3. Specifically, the AP STA may serve as the initiator that initiates the WLAN sensing, and the Non-AP STA may serve as the responder, and may be a monostatic device with sending and receiving functions in the WLAN sensing measurement process. For example, in the WLAN sensing measurement process, each STA (e.g., Non-AP STA A and Non-AP STA B) may serve as a transmitter (TX, transmitter) that sends a WLAN sensing frame to an object to be sensed, and may also serve as a receiver (RX, receiver) that receives feedback from the object, thereby realizing the WLAN sensing measurement.

Measurement manners in a bistatic system and a multistatic system are illustrated in (b) of FIG. 3. Specifically, in the bistatic system, the transmitter (TX) and the receiver (RX) are different devices separate from each other; and in the WLAN sensing measurement process performed under a bistatic collaboration, the two bistatic systems share the same TX, as shown in (b) of FIG. 3, the receivers, RX1 and RX2, share the same TX. That is, in the WLAN sensing measurement process, the TX sends a WLAN sensing frame to an object to be sensed, and the RX1 and RX2 receive feedback from the object, thereby realizing the WLAN sensing measurement. The multistatic system may be similar to the bistatic collaboration manner, e.g., in the multistatic system, one TX corresponds to two RXs (e.g., RX1 and RX2 shown in (b) of FIG. 3), however, the embodiments of the present disclosure are not limited to this, and one TX site may correspond to a greater number of RXs.

According to (b) of FIG. 3, in bistatic systems and multistatic systems, some sites may serve as the RX and some sites may serve as the TX, and it is also required to determine the directionality of the RX and the directionality of the TX in order to perform object sensing. However, in the current research, WLAN sensing measurement methods in bistatic systems and multistatic systems are not well developed.

In view of this, a communication method and a communication apparatus for WLAN sensing measurement are provided according to the embodiments of the present disclosure.

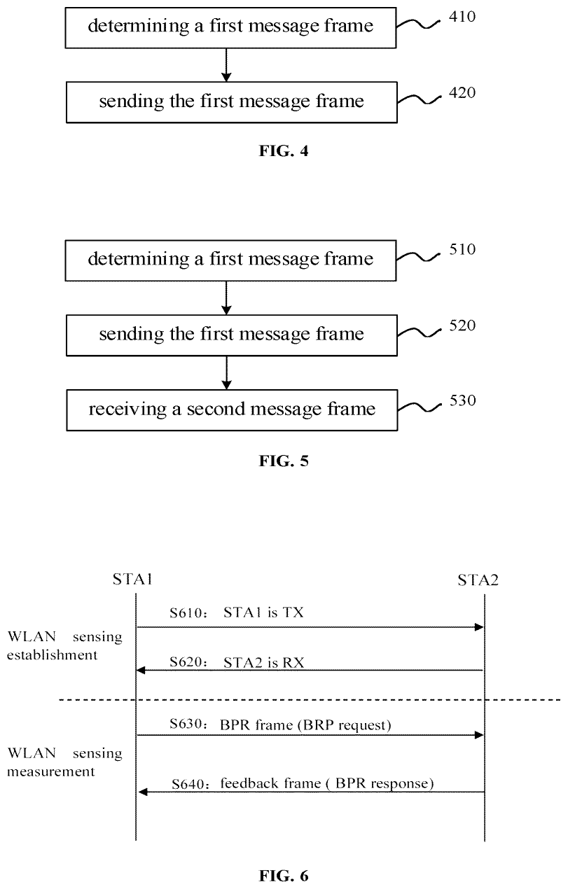

FIG. 4 is a flowchart illustrating a communication method according to an embodiment. The communication method shown in FIG. 4 may be applied to a first device. The first device may be any site in the bistatic system and the multistatic system. For example, the first device may be a transmitter and/or a receiver, and the specific role information of the first device may be identified by first information to be described below.

Referring to FIG. 4, in step 410, the first device determines a first message frame; and in step 420, the first device sends the first message frame. According to an embodiment of the present disclosure, the first message frame may carry information related to the first device performing the communication method of FIG. 4, and the first message frame may be of any type, which is not limited in the present disclosure. For example, but without limitation, when the first device performing the communication method of FIG. 4 is a transmitter, and the transmitter also serves as an initiator of the WLAN sensing, the first message frame may be a WLAN sensing establishment message frame.

In an embodiment of the present disclosure, the first device may determine the first message frame in a variety of ways, e.g., the first message frame may be generated or configured based on at least one of: a channel state, a network condition, a load condition, a hardware capability of the device, a service type, or a relevant protocol stipulation; and the embodiments of the present disclosure do not make specific limitations on this. In an embodiment of the present disclosure, the first device may also obtain the first message frame from an external device; and the embodiments of the present disclosure do not make specific limitations on this.

For example, the first message frame may include first information for identifying and related to the first device. For example, the first information may define an operational parameter of the first device in the WLAN sensing measurement. According to an embodiment of the present disclosure, the first information may include first identification information for identifying that the first device is a receiver and/or a transmitter of a WLAN sensing frame.

In other words, the first information in the first message frame may identify whether the first device performing the communication method of FIG. 4 serves, in the WLAN sensing measurement, as the receiver, the transmitter, or both the receiver and the transmitter. In an embodiment of the present disclosure, the WLAN sensing measurement may be performed through the WLAN sensing frame, e.g., the transmitter (TX) sends the WLAN sensing frame to the object, and the receiver (RX) may obtain the WLAN sensing measurement result by receiving feedback of the WLAN sensing frame from the object. As a non-limiting embodiment, the WLAN sensing frame may be a beam refinement protocol (BRP) frame. For example, a training field (TRN) may be carried in the BRP frame. For example, specifically, the first identification information may be identified by one bit in the first message frame, e.g., the bit being “I” identifies that the first device is the TX, and the bit being “O” identifies that the first device is the RX. For another example, the first identification information may be identified by two bits in the first message frame, for example, a first bit of the two bits identifies the RX, and a second bit of the two bits identifies the TX. For example, but without limitation, the first bit being “1” identifies that the first device may serve as the RX, the second bit being “1” identifies that the first device may serve as the TX, and both the first bit and the second bit being “1” identifies that the first device may serve as both the RX and the TX.

According to another embodiment of the present disclosure, the first information in the first message frame may further include first directionality information of an antenna of the first device. For example, when the first identification information indicates that the first device is the TX, the first directionality information may indicate a directionality of the first device for sending a BRP frame (or a BRP request frame); and when the first identification information indicates that the first device is the RX, the first directionality information may indicate a directionality of the first device for receiving a BRP frame (or a BRP request frame). In an embodiment of the present disclosure, the first directionality information may refer to information such as an azimuth, an elevation direction (or a direction map) and/or a power of the antenna of the first device.

The first information (e.g., the first identification information and the first directionality information) in the first message frame may be determined and sent in a WLAN sensing measurement establishment. According to the embodiment of FIG. 2, one WLAN sensing session establishment may include one or more WLAN sensing measurement establishments, one or more WLAN sensing measurement establishments may include one or more bursts, and a burst may include one or more WLAN sensing measurement exchanges (sensing instances). The first identification information and the first directionality information may be the same or different in different WLAN sensing measurement establishments, may be the same or different in the same WLAN sensing measurement establishment, may be the same or different in different bursts, and may be the same or different in the same burst. Thus, the first identification information and the first directionality information may correspond to a WLAN establishment identifier, a burst identifier and a WLAN sensing measurement exchange identifier.

Specifically, the first information in the first message frame may further include a first WLAN sensing measurement establishment identifier and a first burst identifier, where the first identification information and the first directionality information may correspond to the first WLAN sensing measurement establishment identifier and the first burst identifier.

For example, when pieces of the first identification information and pieces of the first directionality information are different for different WLAN sensing measurement establishments or different for different bursts, the first information may be as shown in Table 1 below.

TABLE 1

| | | | | | | | |
|---|---|---|---|---|---|---|---|
| Measurement setup ID1 | Burst ID1 | RX/TX1 | Direction1 | Burst ID2 | RX/TX2 | Direction2 | . . . |

In Table 1, the first information may include the first WLAN sensing measurement establishment identifier (Measurement setup ID1, etc.), the first burst identifier (Burst ID1, Burst ID2, etc.) that corresponds to the first WLAN sensing measurement establishment identifier, the first identification information (RX/TX1) and first directionality information (Direction1) that correspond to the first burst identifier Burst ID1, and the first identification information (RX/TX2) and first directionality information (Direction2) that correspond to the first burst identifier Burst ID2, etc.

For example, when pieces of first identification information are different in a same burst or pieces of first directionality information are different in a same burst, the first information may further include first WLAN sensing measurement exchange identifiers, and the first identification information and the first directionality information may correspond to the first WLAN sensing measurement exchange identifier. As a non-limiting embodiment, the first information may have a format as shown in Table 2 below.

TABLE 2

| | | | | | | | | |
|---|---|---|---|---|---|---|---|---|
| Measurement setup ID1 | Burst ID1 | Instance ID11 | RX/TX11 | Direction11 | Instance ID12 | RX/TX12 | Direction12 | . . . |

In Table 2, the first information may include the first WLAN sensing measurement establishment identifier (Measurement setup ID1, etc.), the first burst identifier (Burst ID1, etc.) that corresponds to the first WLAN sensing measurement establishment identifier, the first WLAN sensing measurement exchange identifier (Instance ID11. Instance ID12, etc.) that corresponds to the first burst identifier (Burst ID1), the first identification information (RX/TX11) and first directionality information (Direction11) that correspond to the first WLAN sensing measurement exchange identifier Instance ID11, and the first identification information (RX/TX12) and first directionality information (Direction12) that correspond to the first WLAN sensing measurement exchange identifier Instance ID12, etc.

It will be understood that the first information shown in Tables 1 and 2 is only exemplary, and the present disclosure is not limited thereto, e.g., each of Tables 1 and 2 may include more information, or some information may be omitted from each of Tables 1 and 2.

For example, each of Tables 1 and 2 may further include a greater number of first WLAN sensing measurement establishment identifiers (e.g., which may be identified as Measurement setup ID2, Measurement setup ID3, etc.) and their respective corresponding first burst identifiers, first WLAN sensing measurement exchange identifiers, first identification information, and/or first directionality information.

For example, each of Tables 1 and 2 may further include one or more WLAN sensing session establishment identifiers and their corresponding WLAN sensing measurement establishment identifiers, etc.

For example, the first WLAN sensing measurement establishment identifier (Measurement setup ID1) may be omitted from Tables 1 and 2 when only one WLAN sensing measurement establishment is included.

For example, when the WLAN sensing measurement establishment includes only one burst or when the first identification information and the second identification information are the same in different bursts, the first burst identifier (Burst ID1, Burst ID2, etc.) may be omitted from Tables 1 and 2.

For example, when pieces of the first identification information are the same in the same burst and pieces of the first directionality information are the same in the same burst, the first WLAN sensing measurement exchange identifier (Instance ID11, Instance ID12, etc.) may be omitted from Table 2.

For example, the first directionality information may be omitted from Tables 1 and 2 if the relative position of the other party is known in advance before the WLAN sensing measurement establishment is performed. For example, the initiator (or transmitter) and the responder (or receiver) may estimate (e.g., roughly), before the WLAN sensing measurement establishment is performed, the relative positions of the two parties by using the fine timing measurement (FTM) protocol or information in the local server. If the estimated relative position can be sufficient for the WLAN sensing measurement, the first directionality information may be omitted from Tables 1 and 2. If the estimated relative position is not sufficient for the WLAN sensing measurement, the finer antenna directionality information may be further determined accurately in the WLAN sensing measurement establishment and included in the first message frame to be sent.

It will be understood that the communication method shown in FIG. 4 is only exemplary, and the present disclosure is not limited thereto. For example, FIG. 5 illustrates a flowchart of a communication method according to an embodiment. Steps 510 and 520 in FIG. 5 may be the same as steps 410 and 420 in FIG. 4, and repetitive descriptions of which are omitted for the sake of brevity.

In step 530 of FIG. 5, the first device may receive a second message frame from a second device. For example, the second message frame may be a feedback frame in response to the first message frame, however, the present disclosure is not limited to this, and the second message frame may also be any type of message frame containing information related to the second device. According to an embodiment of the present disclosure, the second message frame may include second information for identifying and related to the second device. For example, the second information may define an operational parameter of the second device in the WLAN sensing measurement. For example, the second information may include second identification information for identifying that the second device is the receiver and/or the transmitter of the WLAN sensing frame. For another example, the second information may further include second directionality information of an antenna of the second device. As another example, the second information may further include a second WLAN sensing measurement establishment identifier and a second burst identifier, where the second identification information and the second directionality information may correspond to the second WLAN sensing measurement establishment identifier and the second burst identifier. As another example, when pieces of second identification information are different in a same burst or pieces of second directionality information are different in a same burst, the second information may further include second WLAN sensing measurement exchange identifiers, and the second identification information and the second directionality information may correspond to the second WLAN sensing measurement exchange identifier.

In an embodiment of the present disclosure, the second information related to the second device (e.g., the second identification information, the second directionality information, the second WLAN sensing measurement establishment identifier, the second burst identifier, and the second WLAN sensing measurement exchange identifier) may be substantially similar to the first information related to the first device (e.g., the first identification information, the first directionality information, the first WLAN sensing measurement establishment identifier, the first burst identifier, and the first WLAN sensing measurement exchange identifier). That is, the embodiments described with reference to Tables 1 and 2 may be applied to the second information related to the second device, except that Tables 1 and 2 are supposed to refer to the second device rather than the first device, and the repetitive descriptions are omitted herein to avoid redundancy.

In the communication method described in FIGS. 4 and 5 according to the embodiments of the present disclosure, information interaction between the first device and the second device may be performed.

For example, the information interaction may define roles for the RX and TX, i.e., the information for interaction may include role information for the RX and TX. Specifically, the device is specified as the RX (a role of receiving the BRP frame+TRN) or the TX (a role of sending the BRP frame+TRN) in a burst (including a plurality of WLAN sensing measurements exchanges) and/or sensing measurement (including a plurality of bursts); the receiving/sending roles are not the same/the same in different bursts; or the receiving/sending roles may be the same in the same burst. For example, specifically, two bits may be used to identify the role information, e.g., the first bit identifies the RX, and the second bit identifies the TX.

For example, the information interaction may also include interaction of directionality information of antennas of the RX and the TX, i.e., the information for interaction may also include directionality information of the antennas of the RX and the TX. Specifically, in one burst or different bursts, the following information may be identified, the STA of the TX role (transmitter/initiator) and the STA of the RX role (receiver/responder) using different directionality antennas to send/receive BRP frames. For example, the transmitter may use “Directionality 1” to send a BRP request frame, and the receiver may use “Directionality 5” to receive the BRP request frame. For example, but without limitation, the “Directionality 1” may include the azimuth, the elevation direction (or the direction map) and/or the power, etc. of the antenna of the transmitter; and the “Directionality 5” may include the azimuth, the elevation direction (or the direction map) and/or the power, etc. of the antenna of the receiver.

According to an embodiment of the present disclosure, the above information interaction may take place in the WLAN sensing establishment process. The information may be in one-to-one correspondence with the WLAN sensing measurement establishment identifier and the burst identifier; and if pieces of the TX/RX antenna directionality information used in the same burst are not the same, the information for interaction may further include the WLAN sensing measurement exchange identifier.

According to an embodiment of the present disclosure, before using the finer antenna directionality information in the interaction information described above, the transmitter (or initiator) and the receiver (or responder) may roughly estimate the relative positions of the two parties by using the FTM protocol or information in the local server.

FIG. 6 illustrates an information interaction process between a transmitter and a receiver and a sensing measurement process.

Referring to FIG. 6, information that the STA1 is the transmitter (TX) and the STA2 is the receiver (RX) may be interacted in the WLAN sensing establishment via steps S610 and S620. For example, the STA1 may perform the communication method of FIG. 4, and the first identification information in the first message frame may identify that the first device (STA1) is the transmitter; in this case, the first device (STA1) may receive the second message frame from the second device (STA2), and the second identification information in the second message frame may identify that the second device (STA2) is the receiver. As another example, the STA2 may perform the communication method of FIG. 4, and the first identification information in the first message frame may identify that the first device (STA2) is the receiver, in this case, the first device (STA2) may receive the second message frame from the second device (STA1), and the second identification information in the second message frame may identify that the second device (STA1) is the transmitter. In addition, although not shown, directionality information of the STA1 and the STA2, and/or the corresponding WLAN sensing measurement establishment identifier, burst identifier and WLAN sensing measurement exchange identifier, etc. may also be interacted in S610 and S620.

In the WLAN sensing measurement, the TX (STA1) may send a BPR frame (a BRP request) (S630) to the RX (STA2), and the BPR frame may reach the RX (STA2) through the object as shown in (b) of FIG. 3; and the RX may receive the BRP frame, perform the sensing measurement, and provide feedback (a BPR response) (S640) to the TX.

Furthermore, although only one device (STA2) is shown as the receiver in FIG. 6, the present disclosure is not limited thereto, and a plurality of devices serving as receivers may exist for information interaction with the transmitter (STA1) and sensing measurement.

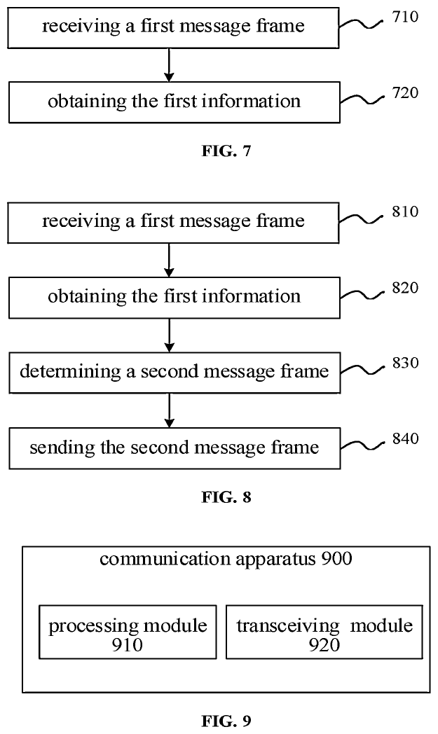

FIG. 7 is a flowchart illustrating another communication method according to an embodiment. The communication method shown in FIG. 7 may be applied to a second device. The second device may be any site in a bistatic system and a multistatic system, and the second device may be opposite the first device that performs the communication method of FIGS. 4 and 5. For example, the second device performing the communication method of FIG. 7 may be a receiver when the first device performing the communication method of FIG. 4 is a transmitter; and the second device performing the communication method of FIG. 7 may be the transmitter when the first device performing the communication method of FIG. 4 is the receiver.

Referring to FIG. 7, in step 710, the second device may receive a first message frame from the first device, where the first message frame may include first information for identifying and related to the first device, and the first information may include first identification information for identifying that the first device is a receiver and/or a transmitter of a WLAN sensing frame. According to an embodiment of the present disclosure, the WLAN sensing frame may be a BRP frame.

According to an embodiment of the present disclosure, the first information may further include first directionality information of an antenna of the first device.

According to an embodiment of the present disclosure, the first information may further include a first WLAN sensing measurement establishment identifier and a first burst identifier, where the first identification information and the first directionality information may correspond to the first WLAN sensing measurement establishment identifier and the first burst identifier.

According to an embodiment of the present disclosure, when pieces of first identification information are different in a same burst or pieces of first directionality information are different in a same burst, the first information may further include first WLAN sensing measurement exchange identifiers, and the first identification information and the first directionality information may correspond to the first WLAN sensing measurement exchange identifier.

The first message frame, the BRP frame, the first information, the first identification information, the first directionality information, the first WLAN sensing measurement establishment identifier, the first burst identifier, and the first WLAN sensing measurement exchange identifier described above may be similar to the embodiment described with reference to FIG. 4, and repetitive descriptions are omitted herein for the sake of brevity.

In step 720, the second device may obtain the first information from the first message frame. For example, the second device that receives the first message frame may parse the first message frame and obtain the first information related to the first device, so as to use the operational parameter of the first device identified by the first information in subsequent WLAN sensing.

It will be understood that the communication method shown in FIG. 7 is only exemplary, and the present disclosure is not limited thereto. For example, in the flowchart of the communication method as shown in FIG. 8, steps 810 and 820 may be the same as steps 710 and 720 in FIG. 7, and repetitive descriptions of which are omitted for the sake of brevity.

In step 830, the second device may determine a second message frame; and in step 840, the second device may send the second message frame. According to an embodiment of the present disclosure, the second message frame may include second information for identifying and related to the second device.

According to an embodiment of the present disclosure, the second information may include second identification information for identifying that the second device is the receiver and/or the transmitter of the WLAN sensing frame.

According to an embodiment of the present disclosure, the second information may further include second directionality information of an antenna of the second device.

According to an embodiment of the present disclosure, the second information may further include a second WLAN sensing measurement establishment identifier and a second burst identifier, where the second identification information and the second directionality information may correspond to the second WLAN sensing measurement establishment identifier and the second burst identifier.

According to an embodiment of the present disclosure, when pieces of second identification information are different in a same burst or pieces of second directionality information are different in a same burst, the second information may further include second WLAN sensing measurement exchange identifiers, and the second identification information and the second directionality information may correspond to the second WLAN sensing measurement exchange identifier.

The second message frame, the BRP frame, the second information, the second identification information, the second directionality information, the second WLAN sensing measurement establishment identifier, the second burst identifier, and the second WLAN sensing measurement exchange identifier described above may be similar to the embodiment described with reference to FIG. 5, and repetitive descriptions are omitted herein for the sake of brevity.

The communication method according to the embodiment of the present disclosure defines the operational parameter during the measurement process in the DMG/EDMG application scenario, thereby adapting to the requirement of WLAN sensing.

FIG. 9 is a block diagram illustrating a communication apparatus according to an embodiment. The communication apparatus 900 in FIG. 9 may include a processing module 910 and a transceiving module 920.

According to an embodiment of the present disclosure, the communication apparatus 900 shown in FIG. 9 may be applied to a first device to perform the communication method shown in FIGS. 4 and 5. For example, the first device may include the communication apparatus 900. For example, the processing module 910 may be configured to determine a first message frame; and the transceiving module 920 may be configured to send the first message frame, where the first message frame may include first information for identifying and related to the first device, and the first information may include first identification information for identifying that the first device is a receiver and/or a transmitter of a WLAN sensing frame. In addition, the transceiving module 920 may be further configured to receive a second message frame from a second device, where the second message frame may include second information for identifying and related to the second device, and the second information may include second identification information for identifying that the second device is the receiver and/or the transmitter of the WLAN sensing frame. The first message frame, the first information and the second information, etc. described above may be similar to the embodiment described with reference to FIGS. 4 and 5, and repetitive descriptions are omitted herein for the sake of brevity.

According to another embodiment of the present disclosure, the communication apparatus 900 shown in FIG. 9 may be applied to a second device to perform the communication method shown in FIGS. 7 and 8. For example, the second device may include the communication apparatus 900. For example, the transceiving module 920 may be configured to receive a first message frame from a first device, where the first message frame may include first information for identifying an operational parameter of the first device in WLAN sensing measurement, and the first information may include first identification information for identifying that the first device is a receiver and/or a transmitter of a WLAN sensing frame. The processing module 910 may be configured to obtain the first information from the first message frame. In addition, the processing module 910 may be further configured to determine a second message frame, and the transceiving module 920 may be further configured to send the second message frame. In some embodiments, the second message frame may include second information for identifying and related to the second device, and the second information may include second identification information for identifying that the second device is the receiver and/or the transmitter of the WLAN sensing frame. The first message frame, the first information and the second information, etc. described above may be similar to the embodiment described with reference to FIGS. 7 and 8, and repetitive descriptions are omitted herein for the sake of brevity.

In addition, the communication apparatus 900 shown in FIG. 9 may be applied to the STA1 or STA2 in FIG. 6 to perform the information interaction process and the WLAN sensing measurement process.

It will be understood that the communication apparatus 900 shown in FIG. 9 is only exemplary, and the embodiments of the present disclosure are not limited thereto, e.g., the communication apparatus 900 may include other modules, for example, a memory module, etc. Furthermore, modules in the communication apparatus 900 may be combined into a more complex module or may be divided into more separate modules.

The communication method and communication apparatus according to the embodiments of the present disclosure define the operational parameter during the measurement process in the DMG/EDMG application scenario, and refine the WLAN sensing measurement method in bistatic systems and multistatic systems, so that they can be adapted to the requirement of WLAN sensing.

Based on the same principle as the method provided in the embodiments of the present disclosure, the embodiments of the present disclosure also provide a communication device including a processor and a memory; where the memory stores a machine-readable instruction (which may also be referred to as a “computer program”); and the processor is configured to execute the machine-readable instruction to implement the method described with reference to FIGS. 4 to 8.

The embodiments of the present disclosure also provide a computer-readable storage medium, where the computer-readable storage medium stores a computer program, and the computer program, when executed by a processor, causes the method described with reference to FIGS. 4 to 8 to be implemented.

In an exemplary embodiment, the processor may be used for implementing or executing various exemplary logic blocks, modules and circuits described in conjunction with the content in the present disclosure, for example, the processor may be a central processing unit (CPU), a general purpose processor, a digital signal processor (DSP), an application specific integrated circuit (ASIC), a field programmable gate array (FPGA), or other programmable logic devices, transistor logic devices, hardware components, or any combination thereof. The processor may also be a combination that implements computing functions, such as a combination including one or more microprocessors, or a combination of a DSP and a microprocessor, etc.

In an exemplary embodiment, the memory may be, for example, a read only memory (ROM), a random access memory (RAM), an electrically erasable programmable read only memory (EEPROM), a compact disc read only memory (CD-ROM), or other compact disc storage, optical disc storage (including compressed optical discs, laser discs, optical discs, digital versatile discs, Blu-ray discs, etc.), disk storage media or other magnetic storage devices, or any other medium capable of being used to carry or store program code in the form of instructions or data structures and capable of being accessed by a computer, but not limited to this.

It should be understood that although various steps in the flowchart of the accompanying drawings are shown in sequence as indicated by arrows, these steps are not necessarily performed in the order indicated by the arrows. Unless explicitly stated in this article, the execution of these steps is not strictly limited in order, and they can be executed in other orders. Moreover, at least a portion of the steps in the flowchart of the accompanying drawings may include multiple sub-steps or multiple stages. These sub-steps or stages are not necessarily executed at the same time, but may be executed at different times. The execution order of these sub-steps or stages is also not necessarily sequential, and these sub-steps or stages may be performed in turn or alternately with other steps, sub-steps of other steps, or at least a portion of the stages.

Although the present disclosure has been shown and described with reference to certain embodiments of the present disclosure, those skilled in the art will understand that various changes in form and details may be made without departing from the scope of the present disclosure. Accordingly, the scope of the present disclosure should not be limited to the embodiments, but should be defined by the appended claims and their equivalents.

1. A communication method for wireless local area network (WLAN) sensing measurement, comprising:
determining, by a first device, a first message frame, and
sending, by the first device, the first message frame; wherein
the first message frame comprises identification used to identify first information related to the first device, wherein the first information comprises first identification information used to identify the first device as at least one of a receiver or a transmitter of a WLAN sensing frame.

2. The communication method according to claim 1, wherein the first information further comprises first directionality information of an antenna of the first device.

3. The communication method according to claim 2, wherein the first information further comprises a first WLAN sensing measurement establishment identifier and a first burst identifier, and
the first identification information and the first directionality information correspond to the first WLAN sensing measurement establishment identifier and the first burst identifier.

4. The communication method according to claim 3, wherein the first information comprises different pieces of first identification information in a same burst, the first information further comprises first WLAN sensing measurement exchange identifiers, and the pieces of the first identification information are in one-to-one correspondence with the first WLAN sensing measurement exchange identifiers; or
the first information comprises different pieces of first directionality information in a same burst, the first information further comprises first WLAN sensing measurement exchange identifiers, and the pieces of the first directionality information are in one-to-one correspondence with the first WLAN sensing measurement exchange identifiers.

5. The communication method according to claim 1, further comprising:
receiving, by the first device, a second message frame from a second device, wherein
the second message frame comprises identification used to identify second information related to the second device, wherein the second information comprises second identification information used to identify the second device as at least one of the receiver or the transmitter of the WLAN sensing frame.

6. The communication method according to claim 5, wherein the second information further comprises second directionality information of an antenna of the second device.

7. The communication method according to claim 6, wherein the second information further comprises a second WLAN sensing measurement establishment identifier and a second burst identifier, and
the second identification information and the second directionality information correspond to the second WLAN sensing measurement establishment identifier and the second burst identifier.

8. The communication method according to claim 7, wherein the second information comprises different pieces of second identification information in a same burst, the second information further comprises second WLAN sensing measurement exchange identifiers, and the pieces of the second identification information are in one-to-one correspondence with the second WLAN sensing measurement exchange identifiers; or
the second information comprises different pieces of second directionality information in a same burst, the second information further comprises second WLAN sensing measurement exchange identifiers, and the pieces of the second directionality information are in one-to-one correspondence with the second WLAN sensing measurement exchange identifiers.

9. The communication method according to claim 1, wherein the WLAN sensing frame is a beam refinement protocol frame.

10. A communication method for wireless local area network (WLAN) sensing, comprising:
receiving, by a second device, a first message frame from a first device, wherein the first message frame comprises identification used to identify first information related to the first device, wherein the first information comprises first identification information used to identify the first device as at least one of a receiver or a transmitter of a WLAN sensing frame; and
obtaining, by the second device, the first information from the first message frame.

11. The communication method according to claim 10, wherein the first information further comprises first directionality information of an antenna of the first device.

12. The communication method according to claim 11, wherein the first information further comprises a first WLAN sensing measurement establishment identifier and a first burst identifier, and
the first identification information and the first directionality information correspond to the first WLAN sensing measurement establishment identifier and the first burst identifier.

13. The communication method according to claim 12, wherein the first information comprises different pieces of first identification information in a same burst, the first information further comprises first WLAN sensing measurement exchange identifiers, and the pieces of the first identification information are in one-to-one correspondence with the first WLAN sensing measurement exchange identifiers; or
the first information comprises different pieces of first directionality information in a same burst, the first information further comprises first WLAN sensing measurement exchange identifiers, and the pieces of the first directionality information are in one-to-one correspondence with the first WLAN sensing measurement exchange identifiers.

14. The communication method according to claim 10, further comprising:
sending, by the second device, a second message frame; wherein
the second message frame comprises identification used to identify second information related to the second device, wherein the second information comprises second identification information used to identify the second device as at least one of the receiver or the transmitter of the WLAN sensing frame.

15. The communication method according to claim 14, wherein the second information further comprises second directionality information of an antenna of the second device.

16. The communication method according to claim 15, wherein the second information further comprises a second WLAN sensing measurement establishment identifier and a second burst identifier, and
the second identification information and the second directionality information correspond to the second WLAN sensing measurement establishment identifier and the second burst identifier.

17. The communication method according to claim 16, wherein the second information comprises different pieces of second identification information in a same burst, the second information further comprises second WLAN sensing measurement exchange identifiers, and the pieces of the second identification information are in one-to-one correspondence with the second WLAN sensing measurement exchange identifiers; or
the second information comprises different pieces of second directionality information in a same burst, the second information further comprises second WLAN sensing measurement exchange identifiers, and the pieces of the second directionality information are in one-to-one correspondence with the second WLAN sensing measurement exchange identifiers.

18. The communication method according to claim 10, wherein the WLAN sensing frame is a beam refinement protocol frame.

19-20. (canceled)

21. A communication device, comprising:
a processor; and
a memory storing instructions executable by the processor,
wherein the processor is configured to:
determine a first message frame; and
send the first message frame,
wherein the first message frame comprises identification used to identify first information related to the first device, wherein the first information comprises first identification information used to identify the first device as at least one of a receiver or a transmitter of a WLAN sensing frame.

22. A non-transitory computer-readable storage medium storing instructions that, when executed by one or more processors, cause the one or more processors to perform the communication method according to claim 1.
